(19) United States
(12) Patent Application Publication
(10) Pub. No.: US 2006/0256099 A1
(43) Pub. Date: Nov. 16, 2006

(54) Display and timing controller

(75) Inventor: Tomohiro Tashiro, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/413,151

(22) Filed: Apr. 28, 2006

(30) Foreign Application Priority Data
May 16, 2005 (JP) 2005-142245

(51) Int. Cl. G09G 5/00

(52) U.S. Cl. 345/204

(57) ABSTRACT

In a display, column drivers each drive a display panel based on a clock signal and image data signals out of a timing controller. The timing controller has dual clock output ports for outputting the same clock signal and at least one clock output port for outputting image data signals. Each of the column drivers is connected to either of the dual clock output ports via a first or second clock line of L-configuration, and the data output port is connected to all of the column drivers via data lines of T-configuration.

### BACKGROUND OF THE INVENTION

1. Field of the Invention

The present invention relates to a display and a timing controller mounted thereon, and more particularly, to a signal transmission technology employing a differential signal transmission method.

2. Description of the Background Art

Displays such as liquid crystal displays are provided with a timing controller (hereinafter referred to as “T-CON”) for supplying a clock signal and image data signals synchronized with the clock signal to column drivers (CDs) for driving a display panel. For signal transmission from the T-CON to the column drivers, a transmission method using differential signals (hereinafter referred to as “a differential signal transmission method”) such as a mini-LVDS (Low Voltage Differential Signaling) or RSDS™ (Reduced Swing Differential Signaling) interface technology has widely been used for fewer traces and minimized Electro-magnetic Interference (hereinafter referred to as “EMI”).

A mini-LVDS interface is generally applied to a high resolution display exceeding SXGA resolution (1280×1024 pixels) intended for high frequencies. In this case, driving is usually conducted with a screen divided into left and right halves. More specifically, the T-CON divides image data of one horizontal line into former and latter halves of image data, to be supplied in parallel to two groups of column drivers, respectively. Accordingly, the T-CON is provided with dual output ports for outputting image data signals, one for the left half of the screen and the other for the right half (cf. Japanese Patent Application Laid-Open Nos. 2004-354567 and 2004-205901).

In comparison with the mini-LVDS interface, an RSDS™ interface is often applied to a display with resolution in a low-frequency band lower than the SXGA resolution, and is widely used particularly with XGA resolution (1024×768 pixels). In this case, driving is usually conducted on the whole screen at a time without dividing the screen (cf. Japanese Patent Application Laid-Open No. 2004-45985; FIG. 5). JP2004-45985 proposes a technique of dividing column drivers into several groups and supplying a different clock signal to each of the groups.

Differential lines for transmitting differential signals from the T-CON to column drivers are generally laid out in a T- or L-configuration depending on the T-CON's position.

Column drivers are arranged in a line on one side of a display panel as shown in, e.g., FIGS. 2 to 4, which will be discussed later. In the L-configuration, the T-CON is located at one end of a circuit board connected to the column drivers (near the first or eighth column driver in an 8 column driver system, for example), and differential lines are routed in one direction along the column drivers (see FIG. 5 which will be discussed later).

In the T-configuration, the T-CON is located in the center of a circuit board connected to column drivers (near the fourth and fifth column drivers in an 8 column driver system, for example). Differential lines out of the T-CON branch out to left and right on the way, and are routed from the branch point in the opposite directions along the column drivers (see FIG. 6 which will be discussed later).

As will be described later in detail, the L-configuration can flow less current into buses and produce less signal distortion than in the T-configuration, and is therefore more advantageous in minimizing EMI. However, it is often difficult to employ the L-configuration by placing the T-CON at one end of a circuit board. Accordingly, the T-configuration is popularly used even at present.

### SUMMARY OF THE INVENTION

An object of the present invention is to provide a timing controller and a display capable of achieving improved signal waveform to minimize EMI even when it is difficult to place a T-CON at one end of a circuit board.

According to the present invention, the display includes a timing controller configured to output a clock signal and an image data signal synchronized with said clock signal by a differential signal transmission method, and a plurality of drivers configured to drive a display panel on the basis of said clock signal and said image data signal. The timing controller includes dual clock output ports, each being made up of a differential pair, and each configured to output said clock signal, and at least one data output port made up of a differential pair configured to output said image data signal. Each of said plurality of drivers is connected to one of said dual clock output ports. The at least one data output port is connected to all of said plurality of drivers.

The timing controller according to the present invention outputs a clock signal and an image data signal synchronized with said clock signal by a differential signal transmission method. The timing controller includes dual clock output ports, each being made up of a differential pair, and each configured to output said clock signal, and at least one data output port made up of a differential pair configured to output said image data signal of one complete horizontal or vertical line.

Since the timing controller has dual clock output ports, even when it is difficult to place the timing controller at one end of a board on which the drivers are mounted, clock signal transmission can be made only through an L-configuration without employing a T-configuration. This prevents degradation in clock signal waveform, which in turn minimizes an EMI component resulting from a clock signal. Further, since the data output port is not configured as dual ports, the number of ports (output pins) of the timing controller is prevented from extremely increasing. As will be described later in detail, in an RSDS™ system, for example, an image data signal does not present a critical signal waveform that toggles at the maximum frequency, and accordingly, makes less contribution to EMI than the clock signal. Therefore, when the EMI component resulting from the clock signal is reduced by employing the L-configuration for clock signal transmission, sufficient effects can be obtained.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating the structure of a display and a T-CON according to a first preferred embodiment of the present invention;

FIGS. 2 to 4 are diagrams each illustrating the structure of a conventional display;

FIG. 5 is a diagram illustrating the structure of a conventional display of L-configuration;

FIG. 6 is a diagram illustrating the structure of a conventional display of T-configuration;

FIG. 7 is a diagram illustrating data mapping of RSDS™;

FIGS. 8A and 8B are diagrams each illustrating the results of transmission line simulation for explaining the effects of the invention; and

FIG. 9 is a diagram illustrating a modification of the first preferred embodiment.

### DESCRIPTION OF THE PREFERRED EMBODIMENTS

Preferred embodiments of the present invention will now be described. In these preferred embodiments, a method of transmitting a clock signal and image data signals from a T-CON to column drivers in a display will be described referring to an RSDS™ system. However, the present invention is not limited to the application to the RSDS™ system, but is also widely applicable to signal transmission systems employing a differential signal transmission method such as a mini-LVDS interface.

### First Preferred Embodiment

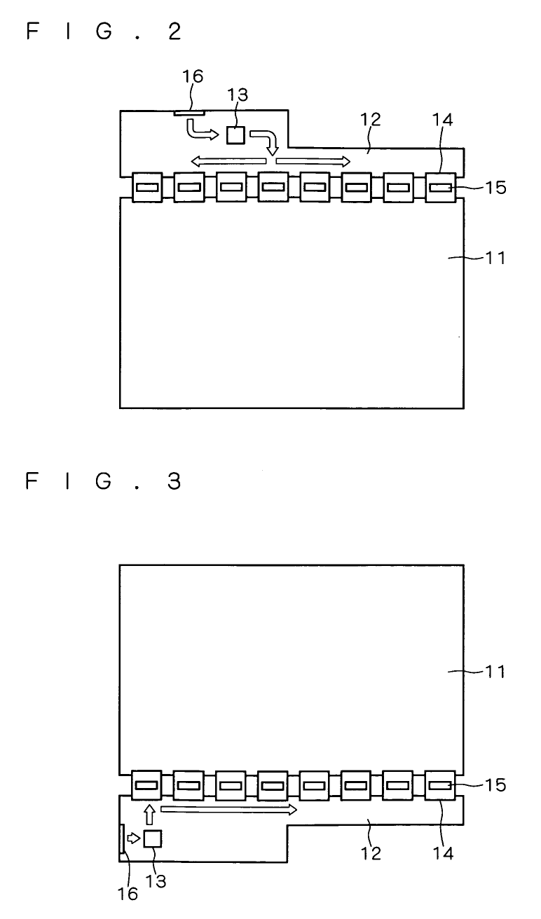

For the sake of convenience, a conventional display will be described prior to discussing the present invention. FIGS. 2 to 4 are diagrams each illustrating a specific structure of a conventional display.

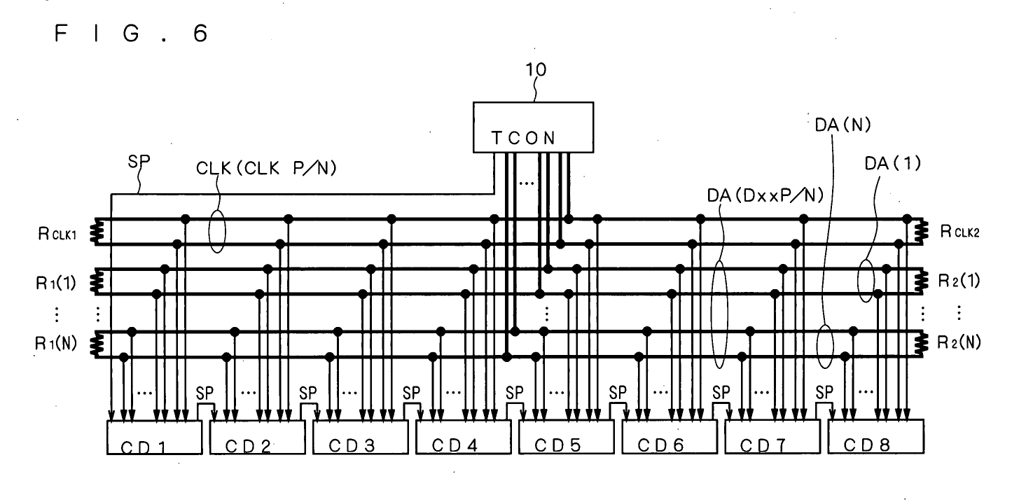

In the example shown in FIG. 2, column drivers 15 for driving a display panel 11 are each mounted on a TCP (Tape Carrier Package) or COF (Chip on Film) 14 (hereinafter referred to as “TCP/COF 14”), and the TCP/COF 14 is connected to the display panel 11 and a circuit board 12 through an anisotropic conductive film (ACF), respectively. In this example, the display has eight column drivers 15. This case corresponds to, for example, the use of column drivers, each having 384 outputs (RGB data of 128 pixels), for driving an XGA display panel (1024×768 pixels). TCP/COFs 14 each having the column driver 15 mounted thereon are arranged on one side of the display panel 11. A T-CON 13 is mounted on the circuit board 12, and is positioned taking into account the positional relationship between an input connector 16 (external input terminal) for inputting a signal to the T-CON 13 and the display panel 11, easiness of routing, and the like. In the example shown in FIG. 2, the T-CON 13 is placed near the center of the circuit board 12. Arrows in FIG. 2 indicate the flow of signal. When placing the T-CON 13 near the center of the circuit board 12, a signal is often divided into two directions near the center of the circuit board 12, and then supplied to each of the column drivers 15 on the left and right sides. The T-configuration is employed in this case (see FIG. 6 which will be described later).

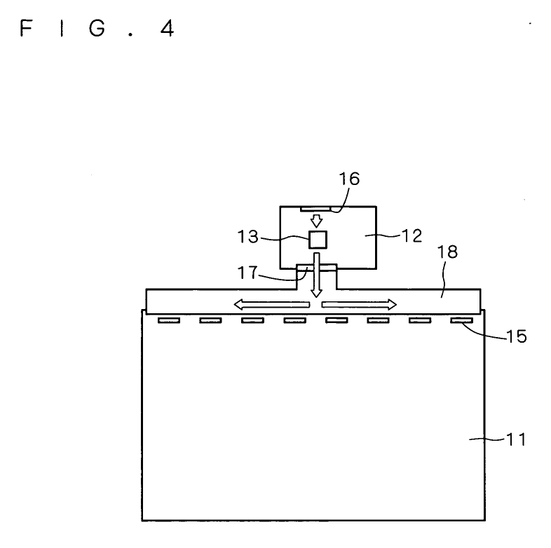

In the example shown in FIG. 3, the T-CON 13 is located at one end of the circuit board 12. In this example, a signal is often transmitted in one direction from the one end of the circuit board 12 along the arrangement of the column drivers 15, and then supplied to each of the column drivers 15. The L-configuration is employed in this case (see FIG. 5 which will be described later).

In both FIGS. 2 and 3, a component-mounting surface of the circuit board 12 (on which the T-CON 13 is mounted) is the same one at which the circuit board 12 is connected to the TCP/COFs 14, but may be the opposite one. In some cases, the column driver 15 is mounted on one side of the TCP/COF 14 that is connected to the circuit board 12 and display panel 11, while being mounted on the opposite side of the TCP/COF 14 in other cases (in general, TCP can be implemented by either of these arrangements, whereas COF can only take the latter arrangement).

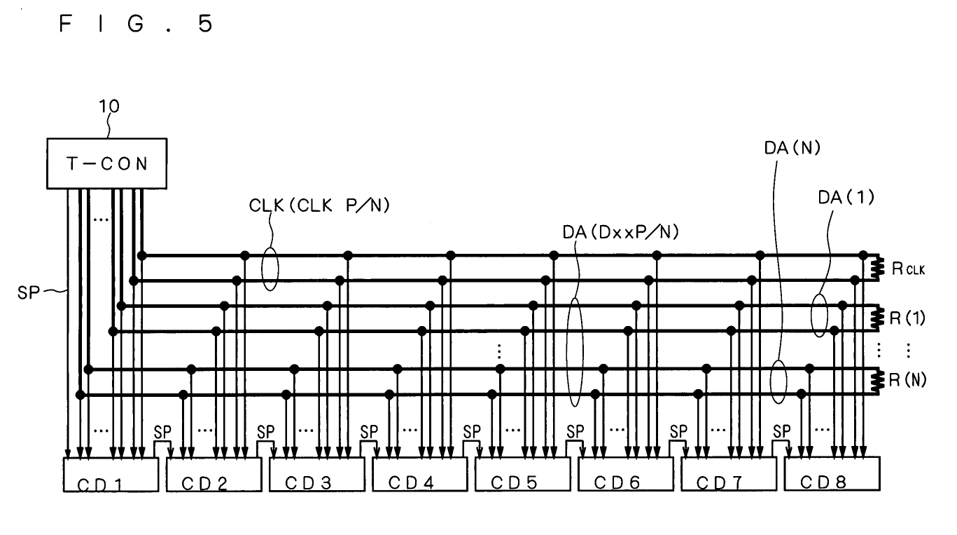

In the above two examples, the column drivers 15 are each mounted on the TCP/COF 14, however, there has been created a mode of COG (Chip On Glass) in recent years in which the column drivers 15 are mounted directly on the display panel 11, as shown in FIG. 4. In this example, the circuit board 12 and display panel 11 are often connected via buses routed on an FPC (Flexible Printed Circuit) 18.

In the case where an FPC connector 17 connected to the circuit board 12 is provided near the center of the FPC 18 as shown in FIG. 4, a signal out of the T-CON 13 is often divided into two directions near the center of the FPC 18, and then supplied to each of the column drivers 15 on the display panel 11. Accordingly, the T-configuration is employed for routing on the FPC 18. Although not shown, when the FPC connector 17 is located at one end of the FPC 18, a signal out of the T-CON 13 is often transmitted in one direction from the one end of the FPC 18 along the arrangement of the column drivers 15, and then supplied to each of the column drivers 15 on the display panel 11. Accordingly, the L-configuration is employed for routing on the FPC 18.

FIGS. 5 and 6 are block diagrams each illustrating the structure of a conventional display, and showing the connection between the T-CON and column drivers in the display.

Each of the displays shown in FIGS. 5 and 6 includes eight column drivers CD1 to CD8 (which hereinafter may generically be referred to as “column driver CD” as well). The column drivers CD1 to CD8 are arranged in this order on one side of the display panel.

Each of the eight column drivers CD1 to CD8 receives a clock signal and image data signals synchronized with the clock signal from a timing controller (hereinafter referred to as “a T-CON”) 10, and drives the display panel on the basis of the signals. A start pulse SP is output from the T-CON 10 with predetermined timing, and transmitted to the column drivers CD1, CD2, . . . and CD8 in this order via a bus which daisy-chains the eight column drivers CD together. Timing with which each of the column drivers CD reads serially-transmitted image data is thereby specified.

According to the present embodiment, transmission of a clock signal and image data signals from the T-CON 10 to the column drivers CD is conducted by the RSDS™ system. For transmission of these signals, differential lines, each made up of a pair of a positive (+) side line and a negative (−) side line (hereinafter also referred to as “a differential pair”), are employed. For ease of description, a differential pair for transmitting a clock signal is called “a clock line”, and a differential pair for transmitting an image data signal is called “a data line”.

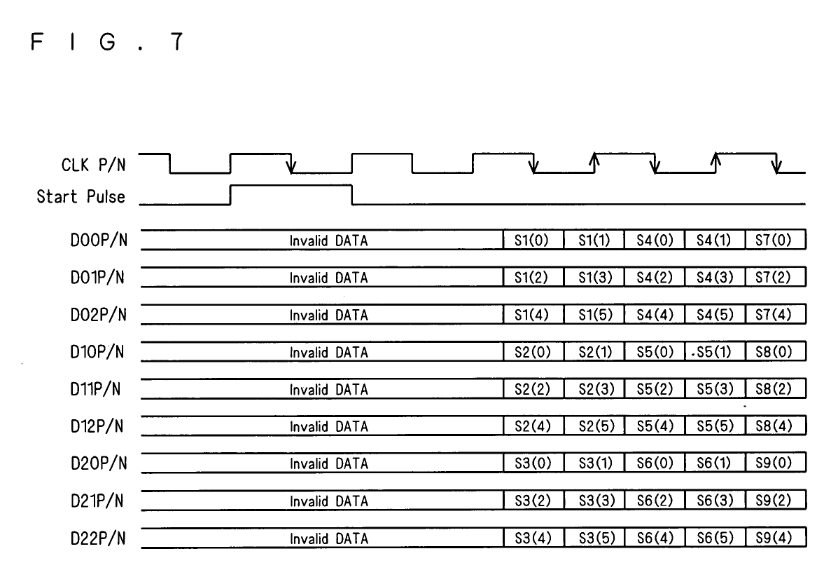

In an RSDS™ display, image data signals are transmitted in parallel in a plurality of bits via a plurality of data lines in order to achieve high resolution while controlling operating frequencies. For instance, FIG. 7 illustrates mapping of 6-bit color RSDS™ data. In the drawing, CLK P/N stands for a clock signal, SP for a start pulse, and DₓₓP/N (xx=00, 01, 02, 10, 11, 12, 20, 21 or 22) for an image data signal. Sn(m) indicates m-th bit data in an n-th line of column driver outputs. The image data signals are subjected to double-edge sampling, and then serially transmitted by 2 bits from the least significant bit via the respective data lines. Accordingly, 6-bit RGB data transmission requires 6×3÷2=9 pairs of data lines. More specifically, assuming N data lines are required, N=9 in an RSDS™ display for transmitting 6-bit RGB data. In an RSDS™ display for transmitting 8-bit RGB data, N=12.

In the conventional display shown in FIG. 5, the T-CON 10 is placed near the column driver CD1 of the column drivers CD1 to CD8, the L-configuration is employed for routing a clock line CLK and N data lines DA(1) to DA(N) (which hereinafter may generically be referred to as “data line DA” as well) for transmitting a clock signal (CLK P/N in FIG. 7) and image data signals (DₓₓP/N in FIG. 7), respectively, from the T-CON 10 to the column drivers CD.

More specifically, the clock line CLK and the respective N data lines DA(1) to DA(N) are routed in one direction from the T-CON 10 along the arrangement of the column drivers CD in the order of the column drivers CD1, CD2, . . . , and CD8. For current-to-voltage conversion and reduced signal reflections, the clock line CLK is terminated by a termination resistor R_{CLK}, and the data lines DA(1) to DA(N) are terminated by termination resistors R(1) to R(N), respectively.

In the above-described L-configuration, the data lines DA and clock line CLK are routed in one direction from one side to the other side of the arrangement of the column drivers CD, and are terminated by the termination resistors, respectively, on the other side. In other words, in the L-configuration, the data lines DA and clock line CLK each have a first terminal connected to the T-CON 10, only one second terminal terminated by a termination resistor R and a third terminal branching out between the first and second terminals to be connected to the column drivers CD.

In the conventional display shown in FIG. 6, the T-CON 10 is located near the column drivers CD4 and CD5 in the center of the column drivers CD1 to CD8. Accordingly, the T-configuration is employed for routing the clock line CLK and data lines DA for transmitting a clock signal (CLK P/N in FIG. 7) and image data signals (DₓₓP/N in FIG. 7), respectively, from the T-CON 10 to the column drivers CD.

More specifically, each of the clock line CLK and N data lines DA(1) to DA(N) extending out from the T-CON 10 branches out between the column drivers CD4 and CD5 into the opposite directions toward the column drivers CD1 to CD4 and toward the column drivers CD5 to CD8. The branches of the clock line CLK and data lines DA extending toward the column drivers CD1 to CD4 are respectively routed to the column drivers CD4, CD3, CD2 and CD1 in this order in the direction away from the T-CON 10 along the arrangement of the column drivers CD1 to CD4, and are terminated by termination resistors R_{CLK1} and R₁(1) to R₁(N), respectively. On the other hand, the branches of the clock line CLK and data lines DA extending toward the column drivers CD5 to CD8 are respectively routed the column drivers CD5, CD6, CD7 and CD8 in this order in the direction away from the T-CON 10 along the arrangement of the column drivers CD5 to CD8, and are terminated by a termination resistors R_{CLK2} and R₂(1) to R₂(N), respectively.

In the above-described T-configuration, the data lines DA and clock line CLK are routed from the center to the opposite ends, and therefore, the opposite ends are terminated. In other words, the T-configuration has two “second terminals” mentioned in the case of the L-configuration.

Unlike the L-configuration, the T-configuration has branches, which tends to cause greater signal reflections, and hence, greater signal distortion. With respect to the aforementioned termination resistor for controlling reflections, the L-configuration requires one termination resistor per differential pair, while the T-configuration requires two termination resistors per differential pair.

In the RSDS™ display, the termination of a differential pair is 100 Ω. Since the T-configuration has two termination resistors on the opposite ends being connected in parallel, an effective impedance is 50 Ω on the RSDS™ outputs of the T-CON 10 (in practical use, the effective impedance decreases under the influence of input capacitance of the column drivers CD and the like, and therefore, a practical termination resistor is often set lower than a theoretical value). Accordingly, to obtain the same signal amplitude as in the L-configuration, an RSDS™ output current of the T-CON 10 needs to be nearly doubled in the T-configuration.

That is, in comparison with the L-configuration, the T-configuration is not very desirable because of its great signal distortion and a great amount of current flowing into buses, which tends to increase EMI. Accordingly, from an EMI reduction standpoint, it is preferable to employ the L-configuration where possible.

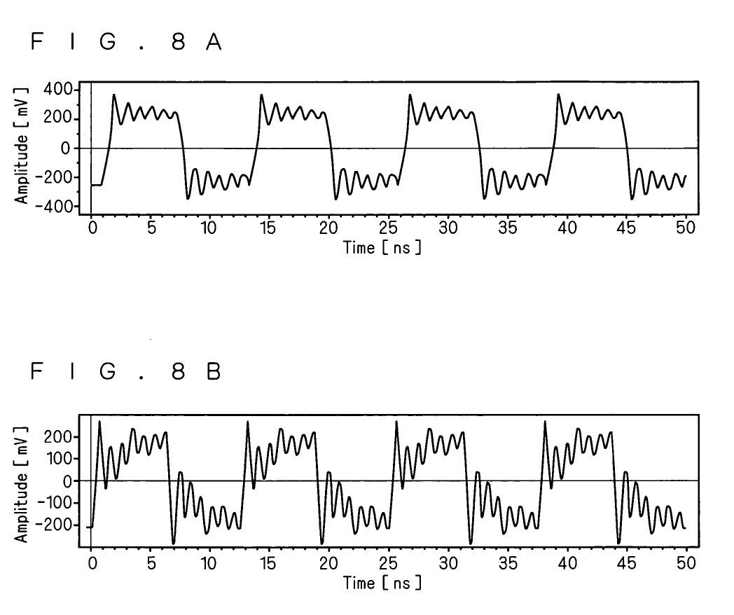

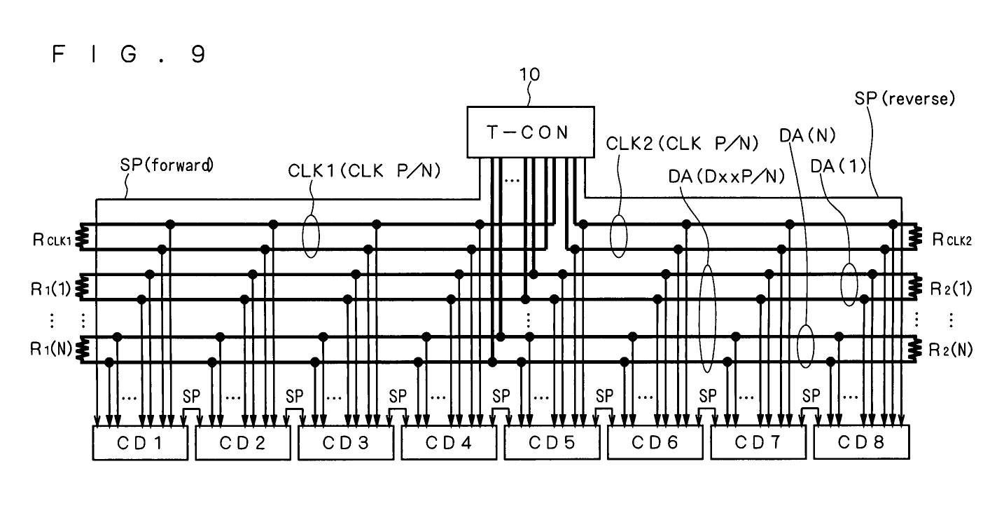

FIGS. 8A and 8B illustrate the results of transmission line simulation assuming an XGA display. In the simulation, differential pairs connected to eight column drivers are assumed. FIG. 8A shows the results of simulation of a differential waveform in the L-configuration, and FIG. 8B shows the results of simulation of a differential waveform in the T-configuration. Each of the diagrams shows a waveform at an input terminal of a column driver. As understood from FIGS. 8A and 8B, the simulation draws the result that the L-configuration (FIG. 8A) has less signal distortion, according to which the superiority of the L-configuration can be confirmed.

The reason why the T-configuration is popularly used even at present irrespective of the superiority of the L-configuration is that it is difficult to always place a T-CON at one end of a circuit board to form the L-configuration. The T-CON's position on a board needs to be determined considering the positional relationship with an external input terminal of a display, easiness of routing, and the like. Besides, an increased board space needs to be suppressed for reducing the cost of the display. Accordingly, the position of the T-CON is limited.

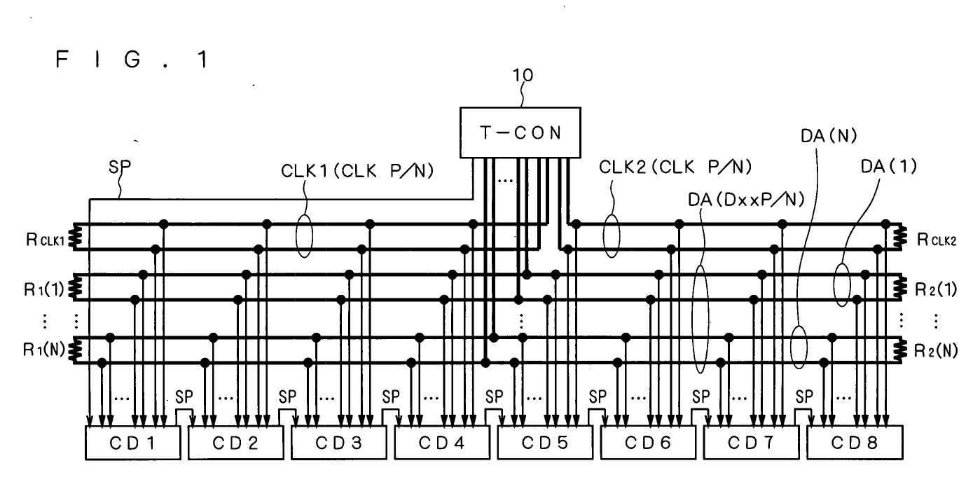

FIG. 1 is a block diagram illustrating the structure of a display and a T-CON according to the first preferred embodiment, and showing the connection between the T-CON and column drivers in the display. In this diagram, elements similar to those shown in FIGS. 5 and 6 are indicated by the same reference characters, and redundant explanation thereof is thus omitted here.

In the display shown in FIG. 1, the T-CON 10 is located in the center of the arrangement of the column drivers CD1 to CD8 (between the column drivers CD4 and CD5). The T-configuration has conventionally been employed in this case as shown in FIG. 6; according to the present embodiment, however, a clock signal (CLK P/N) is transmitted from the T-CON 10 to each of the column drivers CD through two separate L-configurations. More specifically, a clock signal is transmitted via a clock line CLK1 of L-configuration extending out from the T-CON 10 to one end of the arrangement of the column drivers CD (i.e., to the column driver CD1) and a clock line CLK2 of L-configuration extending out from the T-CON 10 to the other end of the arrangement of the column drivers CD (i.e., to the column driver CD8).

In other words, the T-CON 10 according to the present embodiment has dual clock output ports, one connected to the clock line CLK1, and the other connected to the clock line CLK2. Each of these clock output ports is made up of a differential pair. In the present embodiment, these clock output ports each output the same clock signal (CLK P/N). Accordingly, each of the column drivers CD shall be connected to either of the clock lines CLK1 and CLK2. In the example shown in FIG. 1 where the T-CON 10 is located between the column drivers CD4 and CD5, the column drivers CD1 to CD4 are connected to the clock line CLK1, while the column drivers CD5 to CD8 are connected to the clock line CLK2.

As described, since the T-CON 10 has dual clock output ports, two L-configuration buses (clock lines CLK1 and CLK2) can be routed from the T-CON 10 to the opposite sides. Accordingly, even when the T-CON 10 is located near the center of a circuit board on which column drivers are mounted due to the difficulty of placing the T-CON 10 at one end of the board, clock signal transmission can be made only through the L-configuration without employing the T-configuration. Degradation in clock signal waveform is therefore prevented, which in turn minimizes an EMI component resulting from the clock signal.

On the other hand, the T-CON 10 does not have dual data output ports for outputting image data. That is, driving with the screen divided into left and right (or top and bottom) halves is not conducted, unlike the aforementioned mini-LVDS display higher than SXGA resolution. Therefore, the T-CON 10 transmits image data of one horizontal (or vertical) line to each of the column drivers CD without dividing the data. The image data signal of one complete horizontal or vertical line is thus output from each of the data output ports of the T-CON 10. Accordingly, when the T-CON 10 is located near the center of the arrangement of the column drivers CD, the T-configuration is employed for routing the data lines DA as shown in FIG. 1. The EMI component resulting from the image data signals in the display according to the present embodiment is therefore considered almost the same as in the conventional display.

However, in the RSDS™ system, for example, image data signals are serially transmitted by 2 bits from the least significant bit as shown in the data mapping in FIG. 7. Accordingly, unlike the clock signal, the image data signals do not present a critical signal waveform that toggles at the maximum frequency even in a white H-character pattern display against a black background without using halftones that are usually used in EMI measurement (the same can be said in the case of a black character display against a white background). That is, the clock signal has greater contribution to EMI caused by the display than the image data signals. It can therefore be said that achieving improved clock signal waveform is more effective at minimizing EMI. The present invention has been produced giving attention to this feature.

That is, according to the present embodiment, the EMI component resulting from the image data signals is at almost the same level as in the conventional display, however, the EMI component resulting from the clock signal can be reduced, which allows EMI caused by the whole display to be effectively reduced.

In addition to the clock output ports of the T-CON, each data output port may also be configured as dual ports so that both the data lines and clock line can always be routed in the L-configuration. Generally, however, a plurality of data output ports need to be provided in order for parallel output of image data signals. As already described, in the RSDS™ system, for example, 6-bit color RGB data requires 9 pairs of ports, and 8-bit color RGB data requires 12 pairs of ports. Accordingly, configuring each data output port as dual ports will result in an extreme increase in the number of T-CON's ports (output pins), which disadvantageously increases the circuit scale and cost of the T-CON. In other words, the display according to the present embodiment can minimize EMI while controlling the increase in circuit scale and cost of the T-CON.

Further, in FIG. 1, the column drivers CD1 to CD4 are connected to the clock line CLK1 and the column drivers CD5 to CD8 to the clock line CLK2 because the T-CON 10 is located between the column drivers CD4 and CD5. However, the application of the present invention is not limited to such configuration. For instance, when the T-CON 10 must be located between the column drivers CD3 and CD4, the column drivers CD1 to CD3 may be connected to the clock line CLK1, and the column drivers CD4 to CD8 may be connected to the clock line CLK2. That is, to which one of the two clock lines CLK1 and CLK2 each of the column drivers CD is to be connected may be changed appropriately depending on the positional relationship with the T-CON 10. In summary, according to the present embodiment, the clock signal is always transmitted through the L-configuration irrespective of the position of the T-CON 10, which produces the effect of minimizing EMI.

In the case where the T-CON 10 can be located near the column driver CD1 in the present embodiment, a clock line (either of the clock lines CLK1 and CLK2) and data lines DA may be routed in the L-configuration as shown in FIG. 5. Since the T-CON 10 outputs the same clock signal at the dual clock output ports, only either of the dual ports shall be used in this case.

Further, in the present embodiment, the connection between the T-CON 10, column drivers CD and display panel may be made through TCP or COF as shown in FIGS. 2 and 3, or alternatively, through COG as shown in FIG. 4. That is, the data lines DA and clock lines CLK1, CLK2 shown in FIG. 1 may be routed on the circuit board on which the T-CON 10 is mounted, or may be routed on the FPC 18 connecting the circuit board on which the T-CON 10 is mounted and a COG type display panel.

The above description has been directed to a display in which unidirectional scan is always made in the order of the column drivers CD1, CD2, . . . , and CD8, however, the present invention is not limited to such application. For instance, a modification of the present embodiment is shown in FIG. 9, in which the present embodiment is applied to a display intended for bidirectional scan. As shown in FIG. 9, the T-CON 10 has two outputs of start pulse SP, one for forward scan and the other for reverse scan.

In forward scan in the display shown in FIG. 9, the T-CON 10 outputs a start pulse SP (forward) for forward scan to the column driver CD1 with predetermined timing. The start pulse SP (forward) is serially transmitted from the column driver CD1 to CD2, . . . and CD8 in this order via a bus which daisy-chains the eight column drivers CD together, so that each of the column drivers CD operates on the basis of the pulse. In reverse scan, the T-CON 10 outputs a start pulse SP (reverse) for reverse scan to the column driver CD8 with predetermined timing. The start pulse (reverse) is serially transmitted from the column driver CD8 to CD7, . . . and CD1 in this order, so that each of the column drivers CD operates on the basis of the pulse.

In FIG. 9, each trace of start pulse SP connecting two adjacent column drivers CD is illustrated with double-headed arrows. This shows that the direction of transmission of start pulse SP changes depending on the scan direction.

### Second Preferred Embodiment

As already described, the T- and L-configurations each have a different number of termination resistors. Therefore, to equalize the amplitude of a transmitted signal in the both configurations, the T-CON output current needs to be varied. More specifically, the T-configuration requires nearly twice the current in the L-configuration.

Further, an output current of T-CON output buffers directly affects the amplitude of a signal transmitted via the clock line and data line, and therefore, needs to be minimized to the extent possible within a range that satisfies input specifications for the column drivers in order to reduce EMI.

The T-CON 10 according to the first preferred embodiment is assumed to have its dual clock output ports connected to the L-configuration buses (clock lines CLK1, CLK2) and its data output ports connected to the T-configuration buses (data lines DA), as shown in FIG. 1. Accordingly, in this preferred embodiment, the T-CON 10 according to the first preferred embodiment is capable of controlling the output current from output buffers of the data output ports and the output current from output buffers of the clock output ports independently from each other.

The output current from the clock output ports can therefore be set at a value suitable for the L-configuration (e.g., nearly half the output current from the data output ports) while maintaining the output current from the data output ports at a value suitable for the T-configuration.

This allows the amplitude of the clock signal greatly contributing to EMI to be set more suitably, which achieves more effective reduction of EMI. Further, the independent control of the output current from the data output ports and the output current from the clock output ports permits application to various circuit boards, which advantageously results in wide versatility.

When locating the T-CON 10 near the column driver CD1 to route a clock line (either of the clock lines CLK1 and CLK2) and the data lines DA in the L-configuration similarly to FIG. 5, both the data output ports and clock output ports may be set at a current value suitable for the L-configuration.

As means of controlling the output currents from the output buffers of the T-CON 10, the T-CON 10 may be provided with, for example, external resistors, one for controlling the output current from the output buffers of the data output ports and the other for controlling the output current from the output buffers of the clock output ports, and the respective resistors are independently controlled in value, so that the output currents can be controlled.

While the invention has been shown and described in detail, the foregoing description is in all aspects illustrative and not restrictive. It is therefore understood that numerous modifications and variations can be devised without departing from the scope of the invention.

What is claimed is:

1. A display comprising:
a timing controller configured to output a clock signal and an image data signal synchronized with said clock signal by a differential signal transmission method; and
a plurality of drivers configured to drive a display panel on the basis of said clock signal and said image data signal, wherein
said timing controller includes:
dual clock output ports, each being made up of a differential pair, and each configured to output said clock signal; and
at least one data output port made up of a differential pair configured to output said image data signal,
each of said plurality of drivers is connected to one of said dual clock output ports, and
said at least one data output port is connected to all of said plurality of drivers.

2. The display according to claim 1, wherein
said dual clock output ports of said timing controller and said plurality of drivers are connected via two differential lines, and
each of said two differential lines has a first terminal connected to said dual clock output ports, only one second terminal terminated by a termination resistor and a third terminal branching out between said first and second terminals to be connected to said plurality of drivers.

3. The display according to claim 1, wherein
said timing controller is configured to be capable of controlling an output current from said dual clock output ports and an output current from said at least one data output port independently from each other.

4. A timing controller for outputting a clock signal and an image data signal synchronized with said clock signal by a differential signal transmission method, said timing controller comprising:
dual clock output ports, each being made up of a differential pair, and each configured to output said clock signal; and
at least one data output port made up of a differential pair configured to output said image data signal of one complete horizontal or vertical line.

5. The timing controller according to claim 4, wherein
an output current from said dual clock output ports and an output current from said at least one data output port are controlled independently from each other.
